(19) United States
(12) Patent Application Publication
(10) Pub. No.: US 2004/0048644 A1
(43) Pub. Date: Mar. 11, 2004

(54) Gaming device having a progressive award funded through skill, strategy or risk gaming event

(76) Inventors: Peter Gerrard, Prestwich (GB); Anthony J. Baerlocher, Reno, NV (US); Dov L. Randall, Whitefield (GB)

Correspondence Address: BELL, BOYD & LLOYD LLC, P. O. BOX 1135, CHICAGO, IL, 60690-1135, US

(21) Appl. No.: 10/237,197

(22) Filed: Sep. 6, 2002

(51) Int. Cl. A63F 9/24; A63F 13/00; G06F 17/00; G06F 19/00

(52) U.S. Cl. 463/16

(57) ABSTRACT

A gaming device having a skill game event that does not disadvantage an unskilled or inexperienced player. In general, the gaming device levels the playing field for all players by taking some or all the player's losses from the skill game event and distributing them to a progressive payout. That is, when a player loses a skill event, the player can recover or recoup the loss in later play of the gaming device of the present invention. The gaming device may be adapted to distribute the losses into a progressive payout associated with the skill game event, a different randomly game event, a plurality of different randomly game events or to each different randomly game event associated with the paytable of the gaming device.

### CROSS REFERENCES TO RELATED APPLICATIONS

The present invention relates to the following pending commonly owned U.S. patent applications: “Gaming Device Having Odds of Winning Which Increase as a Player's Wager Increases,” Ser. No. 09/687,691, Attorney Docket No. 0112300-483; “Gaming Device Having a Target Bonus Round,” Serial No. 60/229,409, Attorney Docket No. 0112300-030; “Gaming Device Having Perceived Skill Bonus Game,” Ser. No. 09/682,407, Attorney Docket No. 0112300-151; and “Progressive Gaming Device,” Ser. No. 09/966,694, Attorney Docket No. 0112300-487.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The present invention relates in general to a gaming device, and more particularly to a gaming device having a skill, strategy or risk gaming event in which the unsuccessful player is not disadvantaged. In one embodiment of the present invention, award compensation is employed to avoid player disadvantage.

Wagering gaming machines in most jurisdictions are generally games of luck, not skill. Slot machines owe at least some of their popularity to the fact that an amateur, novice or inexperienced player can play most slot machines at the player's own pace, with no required skills, strategy or risk evaluation and perform as well as the seasoned or experienced game player. Most slot machines are set to pay back on average between 80 and 99 percent of the amount of a player's wager. These payouts are randomly determined. Nevertheless, players constantly try to inject skill, know-how or strategy into gaming devices with the hope of turning the odds in their favor.

For example, in the United States there is a consensus as to good and bad slot machine locations. Some players believe that the worst slot machines are the machines near the gaming tables such as the blackjack, baccarat and roulette tables because the players of these games do not want to be distracted by the noise and commotion created by big slot machine winners. Some players believe that, for the same reason, machines near patrons betting on sporting events and horse races are not good locations.

Some players in the United States believe that the best machines are those that are the most visible to others so that other players, or potential players, can see big wins or payouts. Some players believe that the machines near restaurants, cafes or coffee shops have higher payouts because the casinos or other gaming establishments desire to encourage patrons to finish eating and return to gaming. Some players believe that machines near change booths have higher instances of big wins or payouts to entice people in line purchasing tokens to buy more.

Another belief widely held by players in the United States is that slot machines go through a pay cycle, wherein the machines will payout a number of coins to meet the programmed percentage payout after a lull period. Players that believe a pay cycle exists may also generally believe that a non-payout cycle exists, wherein the gaming machine does not payout after a big payout or a pay cycle. The object of players subscribing to these cycle theories is to play good machines and the machines at the right time.

Having a gaming machine truly based on skill or strategy opens the door to players becoming professionals at such games. For purposes of this application, skill includes physical skill, mental skill, emotional skill and any other type of skill. Mental skill includes knowledge and strategy, but knowledge and strategy are sometimes referred to herein separately.

Gaming devices requiring skill or strategy also prejudice unskilled or non-strategic players, so that unskilled or non-strategic players might be reluctant to play such games. For these reasons, many gaming jurisdictions do not allow wagering on games involving skill or strategy. Some jurisdictions set a minimum amount that a machine must pay back, which effectively curtails wagering on games of skill or strategy.

Additionally, even though certain gaming machines such as video poker or blackjack involve certain skill, strategy and decision-making, their outcomes ultimately turn upon mathematics and probability. Other games such as Double-Up and offer/acceptance type bonus games, where a player puts at risk an award won to achieve a higher award, also involve skill and strategy, but their outcomes ultimately turn upon mathematics and probability.

One way to increase player enjoyment and excitement is to provide a gaming device that adds player interaction, skill, strategy or risk to an otherwise random gaming device and at the same time not provide an advantage to the skilled or strategic player or a disadvantage to the non-skilled or non-strategic player.

One way gaming device manufactures have added enjoyment and excitement to gaming devices is through the advent of progressive gaming. Progressive games, which have existed at least since the mid-1980's, have become very popular. Known progressive slot machines contain jackpots that increase every time a player places a wager in a primary game of the slot machine. Progressive jackpots involve one or more gaming machines. For example, an individual progressive slot machine has a self contained jackpot, wherein the jackpot grows with every play of that machine. A linked progressive includes two or more slot machines at the same or different locations connected to a common jackpot, each of which individually contribute to the jackpot. The machines usually take a percentage of the player's wager, such as 2%, and add it to the progressive jackpot. The progressive jackpots can reach sizeable amounts, such as multi-million dollar jackpots, before a player “hits” or wins the progressive jackpot.

Such sizeable progressive jackpots become very attractive to players. Furthermore, as the progressive jackpot grows, so does the game's payout percentage because the game pays out more while the likelihood of receiving the progressive award or jackpot remains constant. Players looking to inject skill or strategy into a gaming event therefore look to find progressive games having relatively high progressive jackpots, i.e., games that have not recently paid out. In an effort to further increase the excitement and enjoyment of progressive games and gaming devices in general, it is therefore desirable to inject player interaction, skill, strategy or risk into a progressive gaming device.

### SUMMARY OF THE INVENTION

The present invention provides a gaming device having a skill, strategy or risk dependent game event, which does not disadvantage an unskilled, unstrategic or inexperienced player. In general, the gaming device levels the playing field for all players by taking some or all the player's losses from the skill, strategy or risk dependent game event and allocating or distributing them to a progressive payout. That is, when a player loses a skill, strategy or risk dependent game event, the player can recover or recoup the loss in later play of the gaming device of the present invention. The gaming device allocates or distributes the losses into a progressive jackpot or payout associated with the skill, strategy or risk dependent game event, a different random game event, a plurality of different random game events or to each different random game event associated with the paytable of the gaming device.

In a further embodiment of the present invention, the gaming device takes some or all of the player's losses from the skill, strategy or risk dependent gaming event and allocates or distributes them to a secondary or bonus game or event, which is triggered by a triggering event in a primary or secondary game of the gaming machine. The allocation may be made directly or indirectly with the full amount or only a portion of the loss. For example, the gaming device could provide extra or free spins or chances in a secondary or bonus event. In another example, the award levels in such events could increase, or the probabilities of winning awards in such events could increase.

It should also be appreciated that the progressive award funded through player losses in the skill, strategy or risk dependent gaming event may also be funded from base or primary games and in particular the wagers thereon. For instance, a percentage of the lost coin or currency would be used to fund the progressive jackpot.

One method of providing a gaming device having a skill game event or skill dependent game event includes displaying a gaming event that produces a winning outcome based upon a player's input and not upon a random generation. The processor of the gaming device recognizes an award associated with the winning outcome. When the processor receives the player's input, if the player's input does not produce the winning outcome, the processor allocates all or at least a portion of the award to a subsequent progressive payout.

This method provides a true skill game event that does not involve a random generation in determining whether the player wins an award. In one embodiment, the skill game event is sufficiently difficult, so that highly skilled players cannot master or easily master the game to the point that the game becomes unprofitable for the casino or gaming establishment. The method may be employed in a primary or secondary game, wherein the bonus game could be structured such that it could be mastered. A winning outcome determination may be a single, all or nothing determination or it may be a determination of whether the player produces enough winning outcomes in a number of tries or chances.

A winning outcome may also be a win of a portion of a potential prize and thus not be an all or nothing determination. Thus, the difference or a portion of the difference between a potential award and the award achieved by the player may be the amount funded to the progressive jackpot. For instance, in a risk type offer/acceptance bonus game, the funded amount can be the difference between an offer actually made to player and rejected by the player and a lower offer actually awarded to the player because the player risked the higher award to obtain the top award, but achieved a lower award. The amount used to fund the progressive is therefore based on what the player risked. In a further embodiment, the amount funded to the progressive jackpot may be the difference or a portion thereof between an expected value and the amount the player received.

In one embodiment, the player is provided the award associated with the skill game event if the player's input produces the winning outcome. In another embodiment, the player is provided the progressive payout if the player's input produces the winning outcome. In this embodiment, the unskilled, inexperienced or nonstrategic player can keep playing the skill event until the player wins the progressive payout and recoups some or all of the player's losses due to unskillful or non-strategic play. In a further embodiment, the player is provided the progressive payout as an outcome of a different random game event. In this embodiment, the unskilled, inexperienced or non-strategic players have the same random opportunity to win the progressive payout as do the skilled, experienced or strategic players.

The skill, strategic or risk dependent game events of the present invention may be adapted in virtually an infinite number of ways. In many cases, when the game provides a touch screen, the player's selection of a particular area on the touch screen produces the winning outcome. In other instances, the player's selection, activation or actuation of a particular electromechanical device produces the winning outcome. In still other instances, the receipt of the player's input at a particular time or within a particular time period produces the winning outcome.

Another method of providing a gaming device having a skill game event includes randomly determining an outcome for the skill gaming event up front. The skill event, as before, requires that the player make an input. The processor again recognizes a particular award for the skill game event. The processor recognizes the input associated with the winning outcome as an expected input. Upon receiving the player's input, the processor allocates at least a portion of the skill event award to a progressive payout if the gaming device randomly generates a winning outcome, but the player makes an unexpected input, that is, does not select an input associated with the winning outcome.

In this method, the present invention randomly generates an outcome, and if the outcome is a winning outcome, the player must successfully perform a skill event to achieve the award of the skill dependent game event. Because the gaming device has randomly generated the winning outcome, albeit unknown to the player, the gaming device preferably adapts the skill event so that the player can easily succeed. The gaming device therefore expects that the player selects an input that produces or is associated with a successful skill event outcome.

Because this method combines a randomly generated outcome with the successful skill event requirement, this method substantially reduces the ability for certain players to master the gaming device and lower its profitability. Further, because this method initially performs a random generation and then displays the skill event, the method can be easily adapted to be added to existing base and bonus games. This method does not change the mathematics of the random game, it merely redistributes some portion of the award to a progressive payout. As in the first method, when the player unsuccessfully plays the skill, strategic or risk dependent game, at least some if not all of the award associated with the skill, strategic or risk dependent game event is allocated to the progressive payout.

In one embodiment, if a winning outcome is generated, the player is provided the award associated with the skill, strategic or risk dependent event if the player makes the expected input. In another embodiment, the player is provided the progressive payout if the player makes the expected input. In a further embodiment, the player is provided the progressive payout as an outcome of a different random game event or a partially random, partially player activated event. As with the first method, the loss can be distributed to one of, a plurality of, or all of the random game events associated with the paytable of the gaming device. The skill, strategic or risk events are also virtually infinitely adaptable as with the first method.

In one embodiment of a progressive payout funded by unsuccessful skill, a skill game such as a shell game is provided. The shell game includes a plurality of shells, one of which hides an object. The shells move, and a player attempts to follow the movement of the shell hiding the object. After the shells stop moving, the player makes an input indicating which shell the player believes is hiding the object. The shells in one embodiment move at a pace, wherein certain but not all observers can follow the shell. The game compensates unskilled players by building a progressive fund based upon unsuccessful play and repaying that fund back to the players randomly upon a successfully played skill, strategy or risk game or another game not related to skill, strategy or risk.

The shell game, as with any of the embodiments described herein, can be adaptively controlled by the processor of the gaming device. With adaptive control, the gaming device stores a desired success rate, such as fifty percent. The processor monitors the actual success rate and adjusts the difficulty level of the skill game (i.e., the rate of movement of the shells) to increase or lower the actual success rate towards the desired success rate.

In another embodiment of the present invention, the gaming device stores a plurality of progressive funds and splits any amount provided for the funds into the various progressive funds. The funds can be built equally or unequally, creating funds that have higher and lower amounts. The funds can also be weighted in terms of how often they pay out, so as to offset varying fund amounts and provide a plurality of funds with the same expected return. In another embodiment, the gaming device pays out an amount randomly to one of the funds, wherein the funds build randomly.

In a further embodiment of the present invention, the gaming device pays back unsuccessful play of a skill, strategy or risk event, not via a progressive payout, but rather through a bonus game or another primary game played in association with the primary game from which the funds are built. In one embodiment, the funds build a bonus payout, which is provided when the bonus game is randomly generated via a designated outcome in the base or primary game. In a different embodiment, the progressive amount increases the likelihood of entering a bonus game that pays out a fixed amount or an amount that varies depending on the funds provided through unsuccessful play.

In still a further embodiment of the present invention, a progressive fund tracking card is provided. The progressive fund tracking card records and stores an amount of funds that the player builds due to unsuccessful play of a skill, strategy or risk event. The card can be specific to a casino or be used in multiple gaming establishments in connection with various gaming machines. The progressive fund card enables the gaming device to eventually payback losses to the player who created them. The card works in a similar manner to a known player tracking cards and can be combined with existing player tracking cards, wherein besides storing the information commonly stored on these cards, the card additionally stores player losses in one or more progressive funds.

It is therefore an advantage of the present invention to provide a gaming device having a skill, strategic and/or risk dependent game event.

Another advantage of the present invention is to provide a gaming device having a skill, strategic and/or risk dependent game event, wherein the successful player receives a progressive payout.

A further advantage of the present invention is to provide a novel method of funding progressive jackpots, wherein the player's inability to use skill or knowledge at least partially funds the progressive jackpot.

Yet another advantage of the present invention is to provide a game of skill that meets randomization and minimum payout regulations of various gaming jurisdictions.

Yet a further advantage of the present invention is to enable players, regardless of their success in a skill, strategic and/or risk dependent game event, to receive a progressive jackpot funded at least in part by unsuccessful skill, strategic and/or risk dependent game events.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIGS. 1A and 1B are perspective views of alternative embodiments of the gaming device of the present invention.

FIG. 2 is a block diagram of the electronic configuration of one embodiment of the gaming device of the present invention.

FIG. 3 is a block diagram of one method of providing a gaming device having a skill dependent game event that does not disadvantage an inexperienced or unskilled player.

FIG. 4 is a block diagram of another method of providing a gaming device having a skill dependent game event that does not disadvantage an inexperienced or unskilled player.

FIG. 5 is an elevation view of one of the display devices illustrating one embodiment of a shell game requiring skill of one embodiment of the present invention.

FIG. 6 is a schematic representation of multiple split progressive funds funded by unsuccessful play of a skill, strategy or risk event.

FIG. 7 is a schematic representation of an award pool for a risk/reward game of the present invention that pays at least a portion of an unsuccessfully played risk event to a progressive fund.

FIG. 8 is a perspective view of a progressive fund tracking card that records and stores one or more personal progressive funds for a player based on unsuccessful play of a skill, strategy or risk event.

### DETAILED DESCRIPTION OF THE INVENTION

### Gaming Device and Electronics

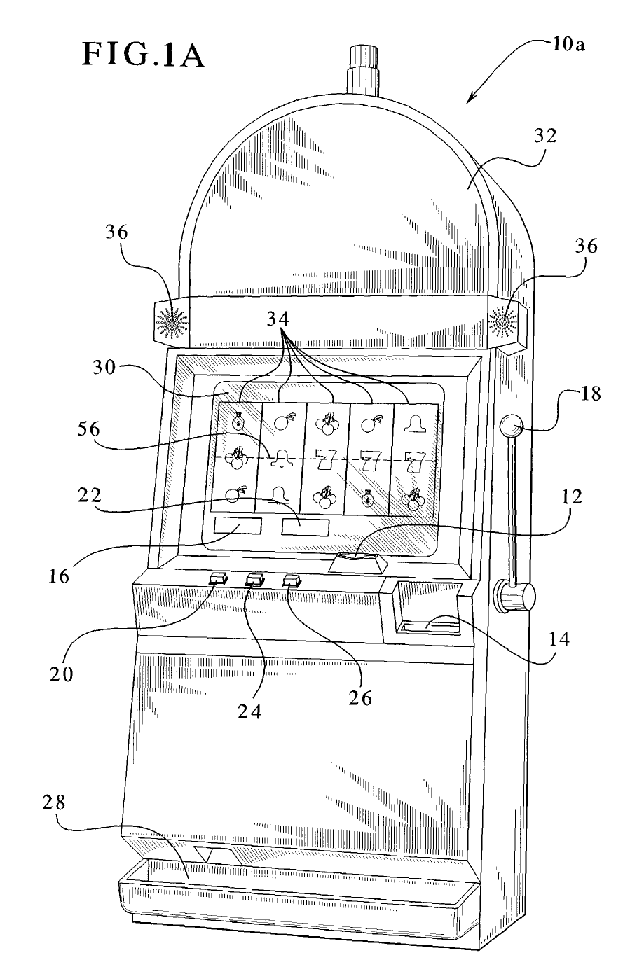

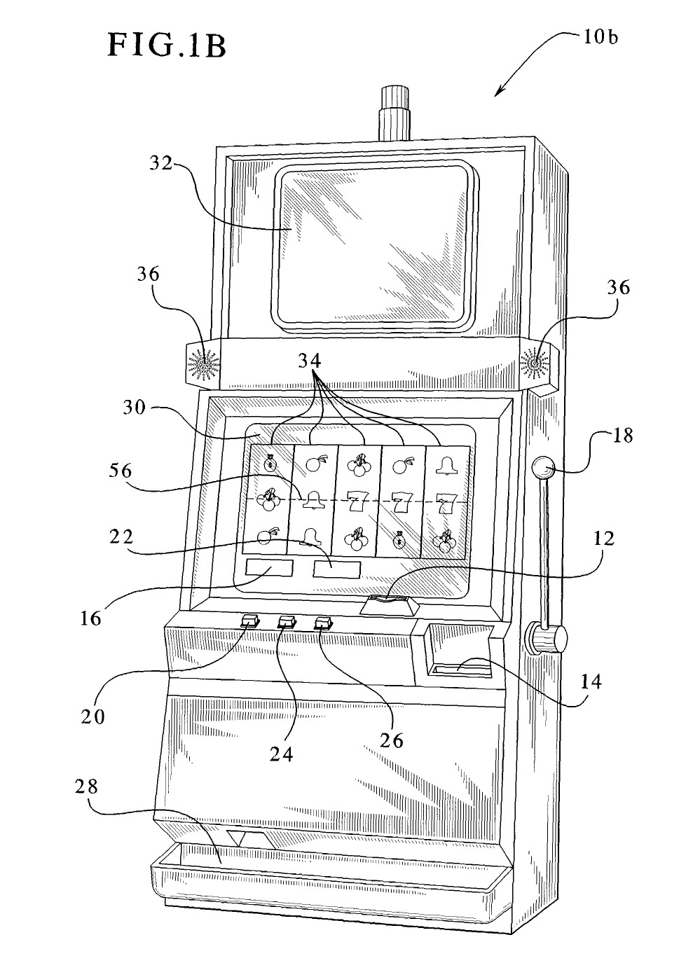

Referring now to the drawings, and in particular to FIGS. 1A and 1B, gaming device 10a and gaming device 10b illustrate two possible cabinet styles and display arrangements and are collectively referred to herein as gaming device 10. The present invention includes a skill, strategic or risk dependent game (examples of which are described below) being a stand alone primary or base game or a bonus or secondary game that coordinates with a primary or base game. When the game of the present invention is a secondary or bonus game, gaming device 10 in one primary or base game is a slot machine having the controls, displays and features of a conventional slot machine, wherein the player operates the gaming device while standing or sitting. The gaming device may also be adapted to be a pub-style or table-top game (not shown), which a player operates while sitting.

The base games of the gaming device may include slot, poker, blackjack or keno, among others. The gaming device also embodies any secondary or bonus triggering events or secondary or bonus games coordinating with these base games. The symbols and indicia used for any of the base, bonus and progressive games include mechanical, electrical or video symbols and indicia.

In a stand alone or a bonus embodiment, the gaming device 10 includes monetary input devices. FIGS. 1A and 1B illustrate a coin slot 12 for coins or tokens and/or a payment acceptor 14 for cash money. The payment acceptor 14 also includes other devices for accepting payment, such as readers or validators for credit cards, debit cards or smart cards, tickets, notes, etc. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any, game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. A player may cash out by pushing a cash out button 26 to receive coins or tokens in the coin payout tray 28 or other forms of payment, such as an amount printed on a ticket or credited to a credit card, debit card or smart card. Well known ticket printing and card reading machines (not illustrated) are commercially available.

Gaming device 10 also includes one or more display devices. The embodiment shown in FIG. 1A includes a central display device 30, and the alternative embodiment shown in FIG. 1B includes a central display device 30 as well as an upper display device 32. The display device includes any viewing surface such as glass, a video monitor or screen, a liquid crystal display or any other static or dynamic display mechanism. In a video poker, blackjack or other card gaming machine embodiment, the display device includes displaying one or more cards. In a keno embodiment, the display device includes displaying numbers.

The slot machine base game of gaming device 10 preferably displays a plurality of reels 34 such as three to five reels 34 in mechanical or video form on one or more of the display devices. Each reel 34 displays a plurality of indicia such as bells, hearts, fruits, numbers, letters, bars or other images which preferably correspond to a theme associated with the gaming device 10. Typically, the display device displays three symbols of each reel, although the display device may be adapted to display any amount of symbols per reel. If the reels 34 are in video form, the display device displaying the video reels 34 is preferably a video monitor. Each base game is also adaptable to include speakers 36 for making sounds or playing music.

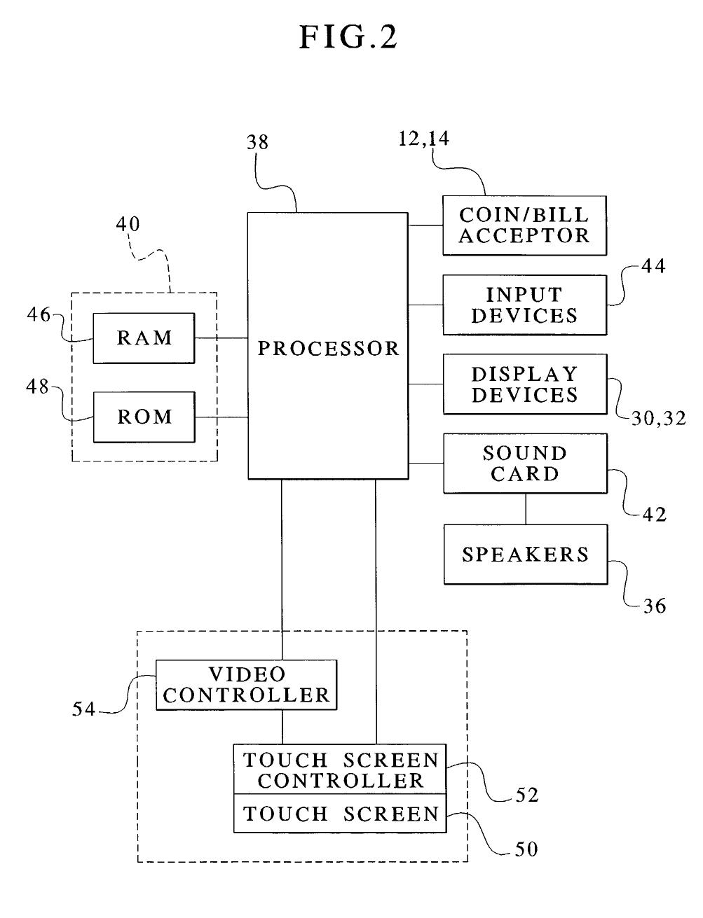

Referring now to FIG. 2, a general electronic configuration of the gaming device 10 for the stand alone and bonus embodiments described above preferably includes: a processor 38; a memory device 40 for storing program code or other data; a central display device 30; an upper display device 32; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. The memory device 40 includes random access memory (RAM) 46 for storing event data or other data generated or used during a particular game. The memory device 40 also includes read only memory (ROM) 48 for storing program code, which controls the gaming device 10 so that it plays a particular game in accordance with applicable game rules and pay tables.

As illustrated in FIG. 2, the player preferably uses the input devices 44 to input signals into gaming device 10. In the slot machine base game, the input devices 44 include the pull arm 18, play button 20, the bet one button 24 and the cash out button 26. A touch screen 50 and touch screen controller 52 are connected to a video controller 54 and processor 38. The terms “computer” or “controller” are used herein to refer collectively to the processor 38, the memory device 40, the sound card 42, the touch screen controller and the video controller 54.

In certain instances, it is preferable to use a touch screen 50 and an associated touch screen controller 52 instead of a conventional video monitor display device. The touch screen enables a player to input decisions into the gaming device 10 by sending a discrete signal based on the area of the touch screen 50 that the player touches or presses. As further illustrated in FIG. 2, the processor 38 connects to the coin slot 12 or payment acceptor 14, whereby the processor 38 requires a player to deposit a certain amount of money in to start the game.

It should be appreciated that although a processor 38 and memory device 40 are preferable implementations of the present invention, the present invention may also be implemented via one or more application-specific integrated circuits (ASIC's), one or more hard-wired devices, or one or more mechanical devices (collectively and/or alternatively referred to herein as a “processor”). Furthermore, although the processor 38 and memory device 40 preferably reside in each gaming device 10 unit, the present invention in one embodiment provides some or all of their functions at a central location such as a network server for communication to a playing station such as over a local area network (LAN), wide area network (WAN), Internet connection, microwave link, and the like.

With reference to the slot machine base game of FIGS. 1A and 1B, to operate the gaming device 10, the player inserts the appropriate amount of tokens or money in the coin slot 12 or the payment acceptor 14 and then pulls the arm 18 or pushes the play button 20. The reels 34 then begin to spin. Eventually, the reels 34 come to a stop. As long as the player has credits remaining, the player can spin the reels 34 again. Depending upon where the reels 34 stop, the player may or may not win additional credits.

In addition to winning base game credits, the gaming device 10, including any of the base games disclosed above, also includes bonus games that give players the opportunity to win credits. The gaming device 10 may employ a video-based display device 30 or 32 for the bonus games. The bonus games include a program that automatically begins when the player achieves a qualifying condition in the base game.

In the slot machine embodiment, the qualifying condition includes a particular symbol or symbol combination generated on a display device. As illustrated in the five reel slot game shown in FIGS. 1A and 1B, the qualifying condition includes the number seven appearing on, e.g., three adjacent reels 34 along a payline 56. It should be appreciated that the present invention includes one or more paylines, such as payline 56, wherein the paylines can be horizontal, diagonal or any combination thereof. Typical slot machines include one, three, five, nine or fifteen paylines 56, wherein nine paylines is very common.

An alternative scatter pay qualifying condition requires the number seven to appear on, e.g., three adjacent reels 34 but not necessarily along a payline 56, to appear on any different set of reels 34 three times or to appear anywhere on the display device the necessary number of times. It is thus easier to achieve a bonus game qualifying condition in a scatter pay than it is when the condition must appear on a payline 56. It is also easier to achieve a bonus game qualifying condition when the condition is able to appear anywhere on a payline 56 than it is when the condition must appear on adjacent reels of a payline 56.

### Methods of the Present Invention

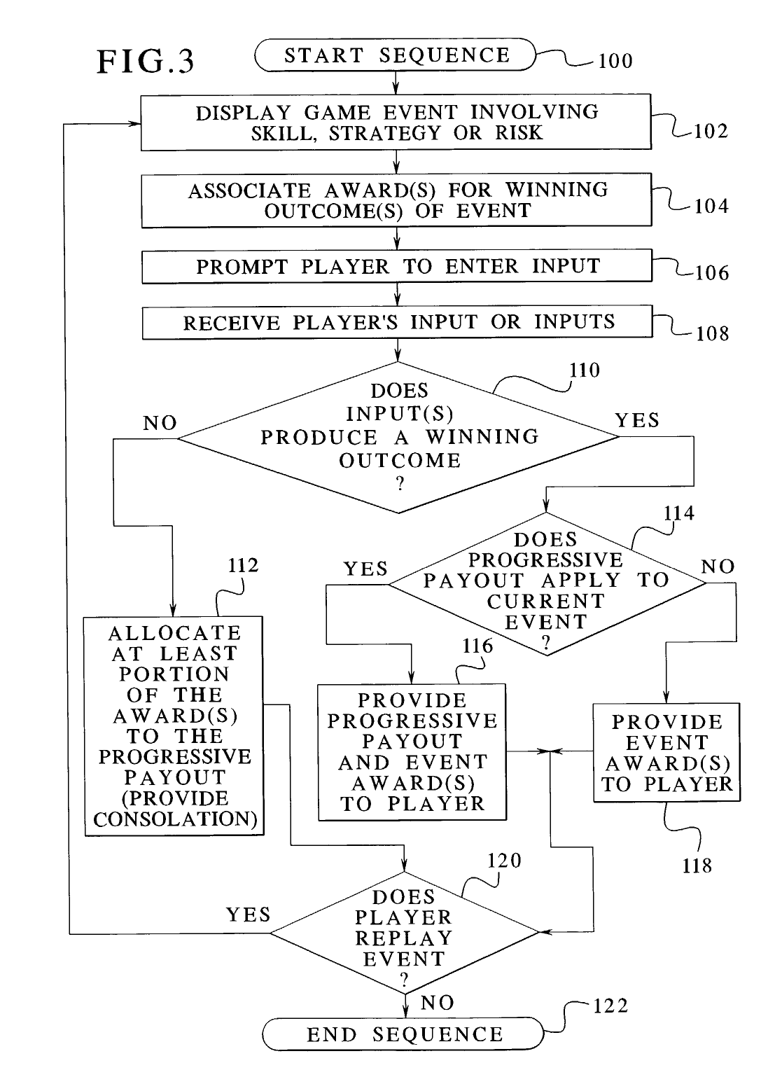

Referring now to FIG. 3, one method for incorporating skill into a gaming event without adversely effecting the payout percentage for novice or unskilled players is illustrated. Upon a triggering event, the sequence starts as indicated by the oval 100. In an embodiment where the game event is a base game or primary game such as slot, poker, keno or blackjack, the sequence triggering event is the wager of at least the minimum amount of money or credits required by the game. In an embodiment where the game is a bonus or secondary game, the sequence triggering event is in one embodiment the achievement of some condition in the base or primary game.

The gaming device 10 displays a game event involving skill on one of the display devices 30 or 32 as indicated by block 102. In this game event, the outcome, whether positive or negative for the player, is in response to or a function of the player's skill performance and not a random generation. It should be appreciated that a negative event may be a fully or a partially negative event, or any event which is not positive.

In one embodiment, the skill game event tests the player's physical ability by timing a player action or input with an event. For example, the game event may be adapted to display a row of moving bottles, wherein the player must press an input to shoot an aimed gun to hit one of the bottles.

In another embodiment, the game event tests the player's physical ability to aim a device at a target. For example, the game event may be adapted to require the player to aim a gun, steer a car, aim a basketball shot, a baseball throw, etc., or maneuver any device having directional flexibility.

The player's ability to time or aim within the skill event involves the player's ability to see and react, e.g., to push a button, steer a wheel, etc., correctly and at the right time. The game event may further be adapted to test the player's physical, yet non-motor skills such as a player's ability to hear and select a sound emanating from a particular location or speaker or to pay attention and listen for vital clues.

Skill can also include a display of one's mental ability. The present invention contemplates requiring the player, for example, to count a plurality of items displayed within the event and to input a selection based on the resulting number. The present invention contemplates requiring the player to perform a mathematical function such as adding, subtracting, multiplying or dividing a plurality of awards or a combination thereof and to make a selection based upon the resulting number.

In a further embodiment, the game event tests the player's mental ability to remember, read or use logical or abstract thinking. For example, the game event may be adapted to momentarily display a plurality of items or values and then require the player to remember where a particular item is located and to make a selection accordingly. In another example, the game event includes a brief display of a plurality of numbers and a display that requires the player to remember and regurgitate the numbers. In a further example, the game event includes the display of a plurality of symbols or items and a display that requires the player to visually match two or more symbols.

In still another embodiment, the game tests the player's general knowledge or knowledge about specific areas of study, academia or trivia. A trivia game is provided in one embodiment having trivia questions with varying levels of difficulty.

The skill events may require the player to act and/or think. The skill events may require a decision by the player other than a guess or mere random selection. For example, choosing one of a plurality of masked values does not require skill. Choosing the one masked value having indicia that the game displayed a moment earlier, however, requires memory, alertness and keen eyesight and therefore requires skill.

The processor 38 game associates an award(s) for a winning outcome(s) of an event involving skill as illustrated by block 104. It is well known to provide a paytable for random game events in the primary or base games. In a slot machine base game embodiment, the gaming device 10 has a paytable that is either permanently physically displayed (usually in the upper glass area of the gaming device) or recallable from one of the display devices 30 or 32.

The paytable lists each winning combination of the symbols displayed by the reels 34. The paytable is also stored in the memory device 40 of the gaming device 10. When the player generates a winning combination of reel symbols, the game recalls the virtual paytable and determines a number of credits to issue to the player.

Likewise, the gaming device 10 maintains a payment regime for the skill events as part of the primary or main game paytable or in a separate paytable. The processor of the gaming device accesses this paytable and recalls or recognizes the skill event payout at the appropriate time. The skill event payout may include a single award or multiple awards as described in more detail below. It should be appreciated that the game may be adapted to recall or recognize the appropriate skill event payout at various points of the present sequence, such as before displaying the game event as indicated by block 102, after prompting the player to enter an input as indicated by block 106 or after receiving the player's input as indicated by block 108. In a risk type embodiment, a predetermined or randomly determined number of award offers could be employed as a skill type event.

At some point during the display of the skill event on the display device 30 or 32, the event prompts the player to enter one or more inputs, as indicated by block 106. To enable input entries, the gaming device 10 provides one or more player interfaces. A player interface includes any apparatus that enables the player to input a selection or decision into the skill event. The player interface may be different depending upon the particular embodiment of the invention.

In an embodiment, the player enters inputs by touching areas of a touch screen 50, which interfaces with the processor 38 and a video controller 54, as illustrated in connection with FIG. 2. The touch screen player interface may be adapted to provide a plurality of input areas, such as a number of directional areas and/or a number of action areas. The directional areas enable the player to steer, direct or aim a displayed item from the touch screen 50. For example, the touch screen 50 directional areas may be adapted so that if a player maintains an input of a directional area, e.g., presses an arrow for an extended time period, the processor 38 receives a series of digital inputs to aim a gun, steer a car, etc.

The touch screen 50 action areas enable the player to perform a certain action at a certain time. For example, the action areas enable the player to shoot a gun, shoot a ball, etc., at a particular point in time in the game event. The action areas also enable the player to enter a decision, such as in a memory, matching, thinking, calculating or logic game.

In an embodiment, the player enters inputs by manipulating external or panel mounted electromechanical devices, which are shown schematically as input devices 44 in FIG. 2. As illustrated in FIG. 2, the external input devices 44 communicate with the processor 38. The external player interfaces are preferably mounted on the gaming device 10 in a suitable location, such as near the play button 20, bet one button 24 or cash out button 26.

The types of or uses for the external player interfaces are substantially the same as for the touch screen 50 player interface. The skill event may therefore be adapted to have some or all of its player inputs be simulated, electromechanical or mixed. The external player interfaces 44 include one or more electromechanical pushbuttons. The external player interfaces 44 may also be adapted in accordance with a theme of the gaming device 10 to be other digital or analog input devices, such as toggle switches, joysticks, digitizers, track balls, mouses, remote controls, steering wheels, and the like.

The external player interfaces 44 may also be adapted to provide directional or action inputs. If the player presses or moves a directional interface for an extended time period, the processor 38 receives a series of digital or analog inputs. The external directional interfaces enable the player to steer, direct or aim an item of the skill event displayed on the display device 30 or 32. The external action interfaces enable the player to input any of the functions or decisions described above for the simulated action areas.

When the processor 38 of the gaming device 10 receives the player's input or inputs, as indicated by block 108, the game in one embodiment decides whether the input produces or yields a winning outcome, as indicated by diamond 110. The determination is made by the processor 38 based on the player's skill and not upon a randomly generated outcome. For example, the processor makes the determination of whether the player wins an award based on whether the player: (i) aims correctly; (ii) shoots a pointed gun at a moving target at the right time; (iii) steers a car correctly; (iv) adds correctly; (v) remembers correctly; (v) matches items correctly; (vi) logically reasons correctly; (vii) recalls a piece of trivia correctly; or (viii) performs any feasible combination thereof correctly. It should be appreciated that those skilled in the art can devise many other skill, strategy or risk dependent game events by which the present invention can evaluate the player.

A predetermined or randomly determined number of skill events may be included in one game. When multiple skill events are used, the events in total can determine a single award, or each event can have an individual award. For example, each car passed in a racing game may yield an individual prize, or the number of cars passed may provide a single prize. The amount funded is based on one or more individual awards or amounts not received by the player.

The skill game event includes randomly generating outcomes for purposes of varying one game event from another, however, the processor 38 does not rely on the random generation to determine the player's award or whether the player receives an award. Similar to the above example, an embodiment includes providing a race car game event, which awards the player based on how many times the player can pass other cars in a given period of time or for a given number of pass attempts. The player successfully passes other race cars by passing to the left or the right. Before beginning the race event, the gaming device 10 randomly generates a winning sequence such as pass left, pass left, pass right, pass left and pass right, which the player must perform to maximize or win an award.

In one embodiment the game event, however, does not make the player guess as to the proper sequence; rather, the game in an embodiment audibly or visually informs the player which way to turn and evaluates the player in some other fashion, such as evaluating the player's reaction time, whether the player reacts correctly, whether the player listens correctly, sees correctly, answers a trivia question correctly, follows clues correctly or turns a wheel or operates a player interface without hitting a wall or running off the road, etc. The gaming device 10 employs the random generation device to vary the sequence from game event to game event and not to determine the player's win. The method of payout can be based on the player's finished location, targets achieved, time to complete a course, or other suitable events.

The skill game may be adapted to define a winning outcome based on a degree or percentage of wins rather than on an all or nothing basis. In the previous race car skill dependent game event for example, the player must exhibit enough skill to pass all five cars to win any award. The game may alternatively be adapted to require the player to pass a certain percentage of cars, such as three out of five, or answer a percentage of trivia questions correctly, such as two out of three.

If the player's input or inputs do not produce a winning outcome, as indicated by diamond 110, the gaming device 10 allocates at least a portion of the award or awards for the gaming event to a progressive payout, as indicated by block 112. That is, the progressive payout is at least partially funded by at least a portion of the award or awards from the gaming event. The game may provide a consolation award to the player. For instance, in the above degree of skill game in one embodiment provides a consolation award for passing two out of five cars or accumulates a consolation award for each car the player passes. In an all-or-nothing skill dependent game event, the game in one embodiment provides a consolation award whenever the player does not achieve a winning outcome regardless of how close the player comes to achieving such.

In one embodiment, the progressive payout is a pot or pool of game credits or money, which is funded at least in part and preferably in total by the player's inability to perform skillfully or skillfully enough. Conventional progressive jackpots or awards (referred to herein as a “progressive payout”) are funded by a percentage of the player's wager. The progressive payout of the present invention is funded at least in part by the player's losses or a portion of the player's losses in a game requiring at least some level of skill. As indicated above, the progressive payout of the present invention may also be partially funded through wagers made by the players. The player's losses can be combined with a percentage of the player's wagers to form an even larger jackpot or progressive payout. As indicated above, the amounts can also be employed in subsequent bonus events, such as subsequent bonus games or free spins.

The payout is progressive because it exists independently from any particular starting and stopping of play. That is, the progressive payout does not cease to exist when the player cashes out and walks away from the gaming device 10. A player can lose repeatedly at a skill game event and not win the progressive payout before cashing out. The next player can place money in the machine and win the jackpot on the first play of the gaming device 10. It should be appreciated that this is the nature of progressive jackpots that are funded by player wagers and distributed through random events.

In accordance with known progressive jackpots, the player losses from a plurality of gaming devices may be linked to form a faster growing and larger value linked progressive jackpot. In this case, when the player wins the skill game event, the player receives the jackpot built from the losses of two or more machines. As indicated above, the gaming machine with the progressive payout could be a stand alone machine having its own progressive pool or a plurality of gaming machines could all contribute to the progressive payout.

The funding of a progressive payout through the player's skill, strategic or risk dependent event losses enables the game implementors to set and hold a particular payout percentage. It should be appreciated that no matter how easy a skill event may be to play successfully, if the gaming device 10 does not return a percentage of the player's losses to the paytable and instead provides the entire loss amount to the casino or gaming establishment, the game cannot guarantee a particular payback percentage. Also, players tend to not play games that do not provide a reasonable pay back. For example, certain players will unsuccessfully add two numbers or misplay a slow-moving hand-eye coordination game. Such a game would therefore not be allowed in certain gaming jurisdictions.

In the skill, strategic or risk dependent game events of the present invention, however, no matter how hard the game event is for a player to successfully play, since the game always allocates an amount of losing credits to the paytable, e.g., through a progressive payout or otherwise, such as in a subsequent bonus game or a number of free spins, the game can guarantee a predefined payback percentage. For example, assume a skill game requires $1.00 to play and pays $1.50 to the player if the player wins (after which player can redeem the $1.50 or keep playing), but keeps the $1.00 wager if the player loses. If the gaming device 10 allocates $0.50 of each dollar lost to a progressive payout, the gaming device can guarantee to payback at least 50% of all player wagers.

The actual payback would be the amount funded to the progressive jackpot plus the other payback on the gaming device. In one example, if one hundred players play and each lose a dollar, the gaming device takes in $50 and allocates the other $50 to the progressive payout. The next player betting a dollar wins the skill event and is credited an additional $51.50, including $1.50 based on the paytable and $50.00 based on the jackpot.

If the player's input or inputs do produce a winning outcome, as indicated by diamond 110, the gaming device 10 decides whether the progressive payout applies to or is associated with the current skill game event, as indicated by diamond 114. If the jackpot applies to the current skill game event, as indicated by block 116, the gaming device 10 provides the jackpot to the player. As illustrated above, the gaming device 10 also preferably provides the award or awards associated with winning the current skill game event.

In the embodiment indicated by block 116, the player's losses fund a progressive payout, as described in connection with block 112, so that the losses increase the award or awards for winning the current skill event. That is, the payout of the paytable for the award or awards of the current skill event, as described in connection with block 104, builds as indicated by block 112 until a player produces a winning outcome, as indicated by diamond 110. The above example where the 101st player to play the skill game event wins $51.50 illustrates this embodiment.

If the jackpot does not apply to the current skill game event, as indicated by block 118, the gaming device 10 provides the award or awards of the associated with the skill game event to the player. In this embodiment, the award of another game event builds as a result of the players skill event losses. That is, the award of another gaming event includes the progressive payout. The other gaming event includes any other gaming event, such as a gaming event involving a randomly generated outcome. In the embodiment indicated by block 118, the gaming device 10 may be adapted to make any payout or combination of payouts of the main paytable progressive.

In one example, including the slot base game illustrated in FIGS. 1A and 1B, the gaming device 10 includes a plurality of reels 34, the payline 56 and the three lucky 7's winning combination. In this example, according to a paytable stored in memory, the three lucky 7's normally pay 100 credits to the player on the next spin of the reels 34 after a player wins the progressive payout of the present invention. That is, the payout for the lucky 7's resets to 100 credits. The game also includes a bonus game, which is the race game described above, wherein the player has to skillfully pass all five cars or a percentage of the five cars to produce a winning outcome as illustrated in connection with diamond 110.

When the player reaches the bonus round and does not exhibit enough skill to pass all five cars, the player wins nothing for playing the bonus round, but the payout for the lucky 7 combination increases or progresses to some number above 100 credits such as 105 credits. When the player returns to the base game, the player has a chance to recoup the lost bonus awards if the gaming device 10 randomly generates the lucky 7 combination along the payline 56. The opportunity to recoup the lost awards is not a function of player skill. Moreover, if the player cashes out, and the next player achieves the lucky 7 combination, the next player recoups the lost bonus award. Thus, the total payout percentage of the gaming device of the present invention is set at a predetermined level.

In this manner, the present invention includes incrementally funding the payouts of a plurality of different winning combinations, i.e., making a plurality of different winning combinations have progressive payouts. In this embodiment, each progressive payout individually resets to a base amount or a starting amount directly after the game randomly generates the particular winning combination. Thereafter, the “spent” winning combination pays the base or starting amount until a skill event loss funds the progressive combination.

It should be appreciated that each of the winning combinations of the main paytable may be adapted to be progressive using the above described method. That is, in an embodiment, the gaming device 10 distributes the skill event loss over the entire paytable. In any gaming device 10 having at least two progressive winning combinations, the present invention splits the skill event loss to fund the progressive payouts as desired by the game implementors. In an embodiment, the gaming device 10 splits the loss evenly among each of the progressive combinations. In another embodiment, the gaming device 10 splits the loss proportionally according to the generation probabilities of each of the progressive combinations. That is, more unlikely combinations receive a larger proportion of the skill event loss than do more likely combinations. In any case, the gaming device preferably rounds up or rounds down any fractions of credits that the apportioning method yields, so that the gaming device only increments the progressive winning combinations by whole numbers of credits.

As stated above, paying back at least a portion of a skill event loss enables the game implemetor to guarantee a particular payback or payout percentage in accordance with the regulations of certain gaming jurisdictions. By funding randomly generated winning combinations, albeit from gaming events involving skill, each player has an equal, i.e., random opportunity to recoup a loss or obtain a bonus award. In essence, the only advantage to the skilled player in this embodiment is that the skilled player is equally likely to receive a randomly generated progressive award while at the same time less likely to forgo, lose or give up the award associated with the skill event.

In an embodiment and in accordance with known progressive payouts or jackpots, the gaming device 10 may be adapted to include, on one of the display devices 30 or 32 or on a separate display device, a display that indicates the winning combination or combinations that are progressive or have progressive payouts. Either the display or the main paytable also displays the base or standard amount that each progressive combination pays. Further, either the display or the main paytable also displays the current amount of each progressive payout.

Displaying a progressive amount can be a huge draw to the machine if the payout or jackpot is large. Conversely, players and especially experienced players will look for large jackpots and shy away from the gaming devices having relatively small jackpots. Therefore, the present invention may be adapted not to display the progressive payouts.

After receiving the player's input as indicated by block 108, determining if the player has provided a winning skill outcome or enough winning skill outcomes as indicated by diamond 110 and funding a progressive payout or jackpot upon a skill event loss or crediting the player upon a skill event win, the gaming device 10 determines whether the player replays the skill event as indicated by diamond 120. If so, the gaming device 10 redisplays the skill event as indicated by block 102. If not, the sequence ends as indicated by the oval 122.

In an embodiment, determining whether the player replays the skill event includes waiting to see if the player presses the play or spin button 20 or cashes out by pressing the cash out button 26. In this embodiment, e.g., a base or primary game embodiment, the player is enabled to replay the skill event as long as the player retains the minimum number of required credits in the credit display 16. In another embodiment, such as when the skill event is embodied in a bonus game, the gaming device 10 may limit the player to playing the skill event one or more times.

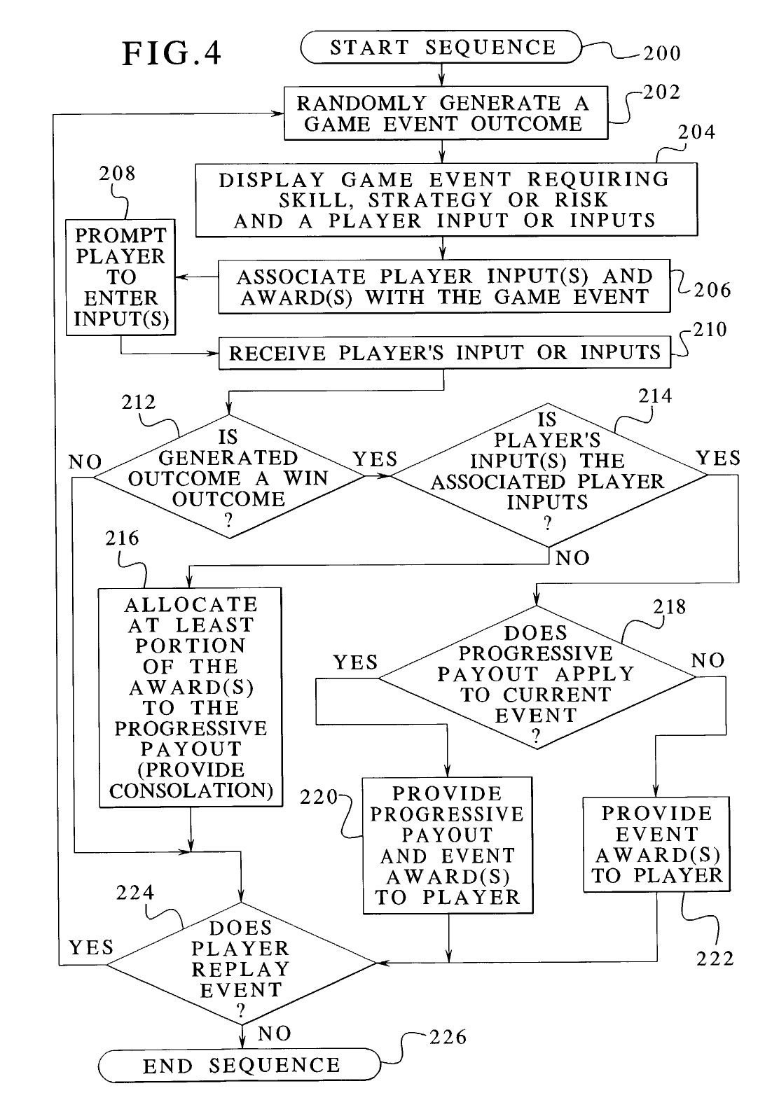

Referring now to FIG. 4, another method for incorporating skill into a gaming event without adversely affecting the payout percentage for novice or unskilled players is illustrated. Upon a triggering event, the sequence starts as indicated by the oval 200. The triggering events may vary depending upon whether the game event is a primary or secondary game, as described above in connection with the oval 100 of FIG. 3. The gaming device 10 randomly generates an outcome, as indicated by block 202. The outcome is either a winning outcome or a losing outcome.

The gaming device 10 may be adapted to generate outcomes in a plurality of ways. In an embodiment, the gaming device employs a non-weighted or weighted database to generate a winning or losing outcome. The term “winning outcome” for the purposes of this embodiment encompasses a single outcome or a plurality of outcomes. That is, the gaming device 10 may be adapted to generate a winning outcome that indicates a degree of success at a skill event requiring a plurality of turns or tries. For instance, in the race car implementation, the outcome generation can determine whether the player passes enough cars such as three out of five, to win.

As described above in connection with block 202, the gaming device 10 of FIG. 4 displays a game event involving skill on one of the display devices 30 or 32 as indicated by block 204. In this game event, although the gaming device 10 randomly determines the outcome, the player must select an input associated with the winning outcome, that is, display a required level of skill to receive the award associated with the skill event. The issuance of an award, therefore, is in response to or a function of the player's skill performance and a random generation. The skill events of the gaming device 10 of FIG. 4 include each of the skill events disclosed in connection with FIG. 3 and therefore include a display of the player's physical ability, mental ability or both.

In the same manner as described above in connection with block 104, in the gaming device 10 of FIG. 4, the gaming device 10 associates player input(s) and award(s) with the winning outcome of the skill event, as indicated by block 206. The gaming device 10 maintains a payment regime for the skill events as part of the primary game paytable or in a separate paytable. The gaming device 10 can access this paytable and recall or recognize the skill event payout at the appropriate time.

The skill event payout may include a single award or multiple awards for skill events having a single award opportunity or multiple tries or opportunities, respectively. It should also be appreciated that the game may be adapted to recall or recognize the appropriate game event payout at various points of the present sequence, such as before displaying the game event as indicated by block 204, after prompting the player to enter an input as indicated by block 208 or after receiving the player's input as indicated by block 210.

The game suitably prompts the player to make one or more input or inputs, as indicated by block 208, using any of the simulated or electromechanical devices disclosed above.

When the processor 38 of the gaming device 10 receives the player's input or inputs, as indicated by block 210, and the gaming device 10 randomly generates a winning outcome, as indicated by diamond 212, the processor 38 decides whether the player inputted an expected input associated with the winning outcome, as indicated by diamond 214. Whether the player's input is the input associated with the winning outcome is based on the player's skill and not upon a randomly generated outcome. This determination is the same the determination that is made in connection with diamond 110, which determines if an outcome is a winning outcome.

Because the gaming device 10 has already randomly generated a winning outcome for the player as indicated by blocks 202 and 212, the gaming device 10 preferably adapts the skill event such that the player is likely to succeed at the event. However, the skill event alternatively has any desired level of difficulty. The gaming device 10 of FIG. 4 is advantageous because it eliminates the possibility that certain players will master the skill event and diminish the profitability of the gaming device 10. That is, the gaming device 10 of FIG. 3 has no check against such mastering and instead relies on making its skill event challenging even to highly skilled players.

Since the player is likely to succeed at the skill event of the gaming device 10 of FIG. 3, the gaming device 10 expects that the player will make the successful input or inputs. For instance, in the race game example, the skill event may be adapted so that the gaming device 10 visually or audibly informs the player whether to pass left or pass right. The gaming device 10 expects the player to select to pass in the disclosed direction. The player, however, may not hear the clue, properly follow the clue or believe the clue and pick to pass in the unsuccessful and unexpected direction.

In another implementation, the gaming device 10 provides a circular set of lights and selectively momentarily illuminates the lights in a circulating pattern. The gaming device 10 requires the player to provide an input while a particular target light is illuminated. The gaming device 10 may be adapted to illuminate the target light for two seconds and thereby give the vast majority of players ample time to successfully make an input. The game therefore expects the player to make an input while the target light is illuminated. In some instances, however, a player will make an input when a non-target light is illuminated.

It should be appreciated that the gaming device 10 of FIG. 4 is also advantageous in that it can be employed as an add-on to many existing random generation games, including primary or base and secondary or bonus games, without changing the mathematics of the random game. That is, if the existing game randomly generates a non-winning outcome (i.e., negative response to diamond 112), the gaming device of FIG. 4 does not alter the random game. If the existing random game randomly generates a winning outcome, the gaming device of FIG. 4 adds a skill requirement to the player's achievement of an award.

If the player does not enter the expected input associated with the winning outcomes, i.e., does not successfully perform the skill event, the gaming device 10 allocates at least a portion of the expected award or awards to a progressive payout as indicated by block 216. That is, the progressive payout is at least partially funded by at least a portion of the expected award or awards. The gaming device may be adapted to provide a consolation award as described above. The gaming device 10 may be adapted to allocate all of the award or awards to the progressive payout or give a percentage to the casino or gaming establishment, as described above in connection with block 112 of FIG. 3. Further, the gaming device 10 may be adapted to allocate some or all of the award or awards to a single progressive payout, to a plurality of progressive payouts or to the payouts of each winning combination of the main paytable.

If the player does enter the input associated with the winning outcome, i.e., successfully perform the skill event, the gaming device 10 decides whether the progressive payout applies to or is associated with the current skill game event, as indicated by diamond 218. If the jackpot applies to the current skill game event, the gaming device 10 provides the progressive payout to the player, as indicated by block 220. The gaming device 10 also preferably provides the award or awards associated with winning the current skill game event.

If the jackpot does not apply to the current skill game event, as indicated by block 222, the gaming device 10 provides the award or awards associated with the skill game event to the player. In this embodiment, the award of another game event builds as a result of the players skill event losses. That is, the award of another gaming event includes the progressive payout. The gaming device 10 may be adapted to make any payout or combination of payouts of the main paytable progressive, as described above.

After determining that the generated outcome is a lose outcome as indicated by diamond 212 or determining whether the player has made the associated input or unexpected input as indicated by diamond 214, the gaming device 10 determines whether the player replays the skill event as indicated by diamond 224. If so, the gaming device 10 generates another game event outcome as indicated by block 202. If not, the sequence ends as indicated by the oval 226. The conditions by which the player replays the skill event in the gaming device of FIG. 4 are the same as disclosed in connection with diamond 120 of FIG. 3.

### Shell Game and Adaptive Skill Event Difficulty

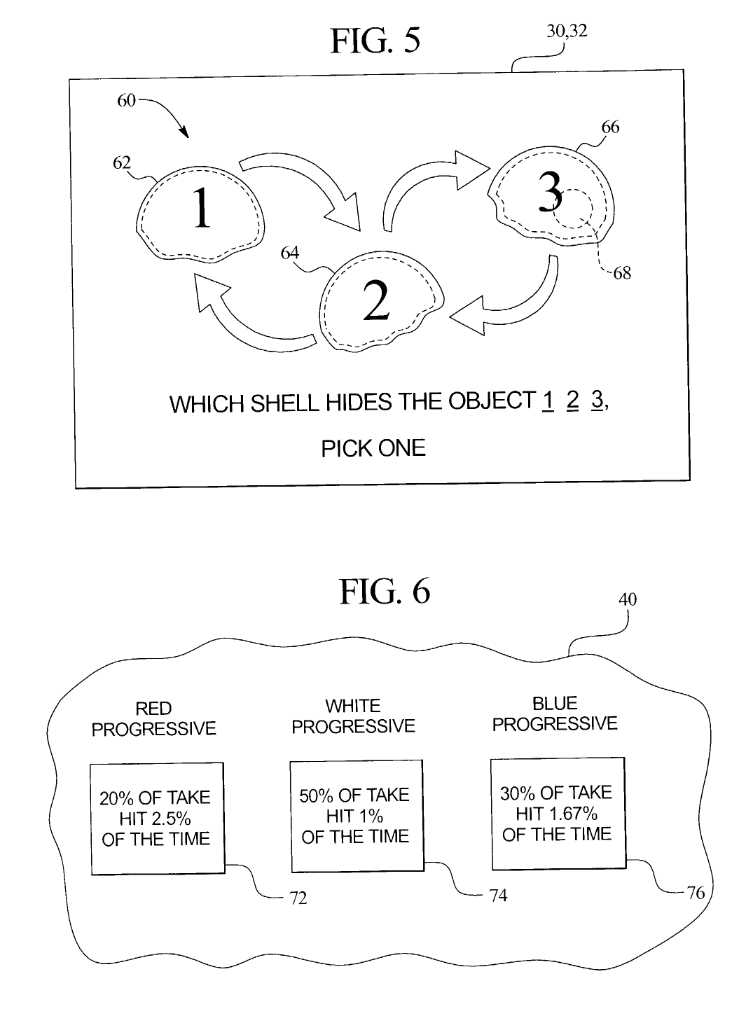

Referring now to FIG. 5, one embodiment of a shell game 60 employing the methods of the present invention is illustrated. The shell game 60 is played on one of the display devices 30 or 32 of gaming device 10. The shell game 60 employs a number of covers or shells and in one embodiment, employs the three illustrated shells 62, 64 and 66. One of the shells covers an object 68. The shell game 60 also provides an instruction to the player to select one of the shells numbered 1, 2 and 3.

Shell game 60 in an embodiment is played in conjunction with a touch screen 50 and touch screen controller 52. Here, the player can simply select one of the shells 62, 64 or 66, depending on which shell the player believes hides the object 68. In an alternative embodiment, gaming device 10 provides one or more electromechanical input devices 44 that enable the player to select one of the shells 62 to 66.

Shell game 60 operates in substantially a similar manner to the well known shell game. Shell game 60 begins by displaying the shells initially opened to show which of the three contains the object 68. Shells 62 to 66 then close so that the player can no longer see object 68. Shells 62 to 66 are then shown swapping places as indicated by the arrows on display device 30 or 32. The skill required in shell game 60 is to be able to visually follow the shell that hides the object 68. In the illustrated embodiment, object 68 is illustrated in phantom beneath shell 66. Shell game 60 can display the shells 62 to 66 moving without an external source or show some type of mechanism, such as a human hand, touch and move the shells 62 to 66. In either case, the shells move in a sliding manner so that the object 68 hidden beneath one of the shells remains invisible to the player.

Shell game 60 operates with any of the embodiments described above. First, shell game 60 can be played as a true skill game in conjunction with the various embodiments set forth in FIG. 3. The speed with which the shells 62 to 66 move can be set so that: (i) people with above average vision can usually follow object 68 but people with below average eyesight cannot usually follow the object 68; (ii) set so that virtually anybody can follow the object 68 hidden beneath one of the shells; (iii) and any variation thereof.

When the shells finish moving and come to a stop, shell game 60 enables the player to pick one of the shells 62 to 66. If the player selects the shell that hides the object 68, gaming device 10 provides an award to the player and may also provide a progressive payout. If the player selects one of the shells that does not hide the object 68, at least a portion of the award that would have been provided to the player is allocated to the progressive payout. As stated above, another portion of the progressive payout can also be made from a percentage of the player's wager.

In an alternative embodiment, shell game 60 operates in connection with the method set forth in FIG. 4. Here, gaming device 10 randomly generates a win or lose outcome. The randomly generated outcome is combined with the player's skill. That is, the player must successfully perform the skill event as well as receive a positive random outcome in order to receive an award and possibly the progressive payouts. Alternatively, the speed that shells 62 and 66 move can be set so high that most or all individuals cannot follow the shell covering object 68. If gaming device 10 randomly generates a positive outcome but the player does not correctly choose the shell that hides the object 68, gaming device 10 allocates at least a portion of the award to the progressive payout.

Whether or not the shell game 60 is impossible for the player to follow or possible for only skilled players to play successfully, the unskilled player is not disadvantaged. Each time the player unsuccessfully plays the skill event, the award that the player would have won or a portion thereof is added back to the progressive payout. In this manner, the unearned awards are eventually paid out to the player in the form of a progressive payout.

Another embodiment of the present invention is aptly illustrated in combination with the shell game 60, wherein gaming device 10 adapts to the player's level of skill. With adaptive skill, gaming device 10 sets a desired success rate for the skill game, for example, fifty percent. The gaming device 10 rotates or shifts the shells 62 to 66 initially at a speed that gaming device 10 assumes will enable the player to play successfully fifty percent of the time. Gaming device 10 tracks the player's success over a number of games, such as five to twenty games, whereafter gaming device 10 adjusts the speed that the shells 62 to 66 are rotated or shifted up or down accordingly to bring the actual success rate closer to the desired success rate.

After a certain number of plays, gaming device 10 can adaptively control the speed after every additional play, every five plays, every ten plays or after any desired number of plays. With shell game 60, gaming device 10 controls the speed at which various objects are moving to achieve a desired skill success rate. In alternative embodiments, gaming device 10 controls other factors. For example, in a trivia game, gaming device 10 can store in memory device 40 various sets of trivia questions having varying difficulties. Assuming a desired success rate again of fifty percent, the gaming device can select questions from harder or easier groups of trivia pools depending upon whether the player is answering more or less, respectively, trivia questions correctly.

In other embodiments, the gaming device controls the time, for example, that a player can view a set of objects before having to recall one or more of the objects at a later time when the objects are no longer visible. The gaming device in a race game can vary the level of competition of the other entries in the race. In a target shooting game, gaming device in an embodiment varies the size of the target based on whether the player is performing above or below a desired success rate. It should be appreciated that the adaptive control embodiments can take a multitude of forms. Each embodiment, however, has a control variable, a desired success rate, a measured actual success rate and an algorithm that controls a difficulty level so that the measured success rate tends toward the desired success rate.

### Splitting Progressives

Referring now to FIG. 6, one embodiment of the gaming device employs a split progressive game, indicated figuratively by the progressive pools 72, 74 and 76 stored in memory device 40. In this embodiment, instead of funding a single progressive payout from unsuccessfully played skill, strategic and risk events, and further potentially from a portion of the player's wager, the gaming device divides up these funds into a plurality of progressive pools. FIG. 6 illustrates three progressive pools 72 to 76 designated respectively as the red progressive, white progressive and blue progressive; however, it should be appreciated that the available funds are alternatively divided into any suitable number of progressive pools. The progressive pools 72 to 76 can operate with any of the embodiments described herein including any of the skill events described and any of the embodiments discussed in connection with FIGS. 3 and 4.

There are a number of factors that are considered in providing a plurality of progressive pools, such as funds 72 to 76. The first factor is how much of the overall available funds are provided to each particular progressive pool. In one embodiment, the funds due to unskilled, non-strategic or non-risky play are divided equally among each of the available pools 72 to 76. Alternatively, in the illustrated embodiment, the pools each take a different percentage of the overall available funding. As illustrated, red progressive pool 72 takes twenty percent of all available funds, white progressive pool 74 takes fifty percent of all available funds and blue progressive pool 76 takes thirty percent of all available funds.

Another factor that is considered in the implementation of the split progressive fund embodiment is the percentage of time that gaming device 10 pays out from a particular pool. As illustrated by diamonds 114 and 218 of FIGS. 3 and 4, respectively, gaming device 10 does not make the progressive payout after each turn of play, rather, gaming device 10 determines randomly whether to make such a progressive payout.

In the illustrated embodiment of FIG. 6, the red progressive pool 72 pays out two and a half percent of the time, white progressive pool 74 pays out one percent of the time and blue progressive pool 76 pays out one and two-thirds percent of the time. Progressive pools 72 to 76 are set up to have the same overall expected return, wherein the more scarcely funded red pool 72 is provided proportionately more often than the most abundantly funded white pool 74. The intermediately funded blue pool 76 is provided to the player in intermediate amount of the time. The funds although illustrated as such do not have to have the same overall expected return. That is, white progressive pool 74, while taking half of each credit available to each of the funds, could also payback the highest percentage of the time.

The split progressive funds are employed by gaming device 10 in a variety of ways. One way is to make the existence of the split funds invisible to the player. That is, gaming device 10 does not have to tell the player which pool the gaming device is paying from. In many cases, it is desirable to display the amount in the pools, wherein gaming device 10 informs the player of such multiple funds and of such potential earnings. The player can also track the building of the various progressive funds 72 to 76 and determine that one or more of the funds grows faster than one or more of the other funds. When one of these funds is paid out to a player, gaming device 10 can inform the player of the fund that has been hit.

In a further alternative embodiment, gaming device 10 combines a skill event game with a strategy-type game, wherein when the player becomes eligible to win a progressive payout, gaming device 10 enables the player to choose which funds to play. It is preferable in this embodiment to make the expected return of each of the funds equal. The player can then decide whether to play for the less available but higher funded payout, or more available but lower funded payout. In one embodiment, whenever one of the funds is paid out to the player, gaming device 10 reallocates the funds from the non-paying progressive pools to the pool that has most recently paid out, in a proportion that immediately refunds the paid out progressive. In this way, after a progressive payout, the funds are automatically reset to provide the same expected return.

In an alternative embodiment, gaming device 10 does not split each credit that is made available for the funds, rather, gaming device 10 in a predetermined or random manner pays all of a particular amount from a non-successfully played skill, risk or strategic event to one of the various progressive funds 72 to 76. That is, gaming device 10 in one instance pays the amount to fund 72, at a different time pays to fund 76 and at a still different time pays to fund 74. In this way, the funds 72 to 76 can grow randomly, wherein one of the funds becomes randomly large, while another of the funds remains randomly low.

### Progressive Paid in Separate Game

In a further alternative embodiment of the present invention, the progressive payout is made in a different game other than the game that funds the one or more progressive funds. FIGS. 3 and 4 generally describe methods, wherein gaming device 10 pays out a progressive award in the same game that funds the progressive fund from which the award is made. In an alternative embodiment, the player's unsuccessful play of a skill, strategy or risk event funds one or more progressive funds in a different game, such as a bonus game. For example, the bonus game can be a bonus game of a primary or base game of poker, wherein the player's non-strategic play of a poker hand funds a progressive pool, which is made available to the player not upon a base game outcome, but rather upon the play of a bonus game, which may be initiated by a poker game outcome.

The progressive fund may be implemented in a separate game in a variety of ways. In one way, the fund is used as a payout of one of more of the secondary or bonus games. Here, entry into the bonus or secondary game is based on the achievement of some outcome in the primary game. In another embodiment, the progressive funding increases the likelihood of entering the bonus or secondary game, wherein the payout is either fixed or otherwise effected by the progressive funds. That is, the build up of unsuccessful payments to the progressive fund can either enhance the award of a bonus or secondary game or make the award more accessible.

The separate game does not have to be a bonus or secondary game of a primary game that funds the progressive pool. In an alternative embodiment, the separate game is another primary game. For example, many video Keno machines operate in the same cabinet with the primary game of video poker or blackjack. Here, an unsuccessfully played strategy or risk event in the game of video poker or blackjack can fund a number of credits provided to the player to play a number of Keno games. In still a further alternative embodiment, the progressive fund is paid out as a number of credits in the primary game that funds the progressive payout.

### Offer/Acceptance

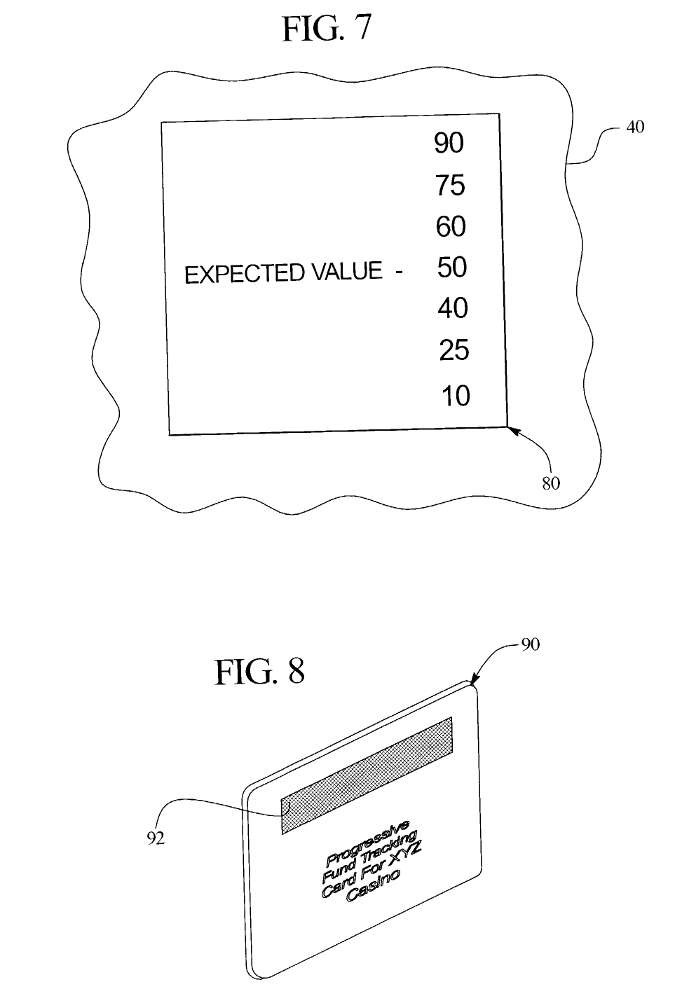

Referring now to FIG. 7, one embodiment of gaming device 10 funds the progressive payout via risk as opposed to a lack of skill or strategy. One illustration of this is provided by an offer/acceptance game using the award pool 80 of FIG. 7, the pool 80 stored in the memory device 40. Offer/acceptance games are known in the art, for example, one popular offer/acceptance game called TOP DOLLAR® is manufactured by the assignee of the present invention. The TOP DOLLAR® game displays the potential awards to the winner, such as the award pool 80 in FIG. 7. Assuming the player has an equal chance of obtaining any one of the awards in award pool 80, the expected value of award pool 80 is fifty as illustrated. On average, the player playing the offer/acceptance game having the award pool 80 should obtain an award of fifty.

The TOP DOLLAR® game in particular displays the award pool to the player and provides an initial offer. If the player desires to keep the initial offer, the player makes an input into gaming device 10 indicating such desire. If the player does not like the initial offer, the player selects a reject offer input, wherein gaming device 10 randomly chooses another award from award pool 80 to offer to the player. Typically, the TOP DOLLAR® game repeats this process a total of three times assuming the player rejects all offers, wherein gaming device 10 automatically provides the final offer to the player as an award.

The offer/acceptance or risk type game is combined with the funding of a progressive pool of the present invention in one embodiment by adding to one or more progressive funds an amount of an award risked: (i) above an expected value and (ii) above a value actually received by the player. For example, if gaming device 10 provides the player an initial offer of sixty and the player rejects the offer of sixty hoping to obtain an offer of seventy-five or ninety, gaming device 10 adds the difference between the offer and the expected value, namely, ten credits (sixty minus fifty) to the progressive fund if the player receives an award below the expected value. So, if after risking the sixty credits, the player ultimately receives an award of only ten, the amount risked, namely, ten credits is added to the progressive fund. In the alternative, the gaming device funds the total difference, fifty credits, between what the player risked and what the player achieved to the progressive pool.

In another alternative embodiment, the gaming device funds the progressive payout with the difference between the expected value and the player's actual value when the actual value is below the expected value. For example, if the player ultimately receives an ultimate award of twenty-five, the gaming device funds the progressive payout with twenty-five (fifty less twenty-five) credits. In this embodiment, the offer that the player foregoes is secondary to the offer that the player ultimately achieves as an award. That is, this second embodiment funds the progressive payout even if a player never receives an offer greater than the expected value. Both embodiments, however, compensate the player for not obtaining at least the expected value. The progressive fund is based on unsuccessful risk taking as opposed to unsuccessful skill or strategy as described above.

### Progressive Tracking Card

Referring now to FIG. 8, a further alternative embodiment of gaming device 10 stores a personal progressive fund on a progressive fund card 90. It is known to provide player tracking cards, typically specific to a gaming establishment, wherein the casino tracks the wagers that the player makes both on video gaming and table games. The casino compensates the player for wagering a certain amount, etc. The present invention includes providing on the same player tracking card or on a separate progressive fund tracking card 90 as illustrated, a memory strip 92 that keeps track of the player's personal identification. The memory strip 92 in an embodiment is a magnetic strip commonly found on credit cards, debit cards and other types of computer readable cards. The tracking system of the gaming establishment keeps track of the personal progressive funds.

The progressive fund tracking card 90 is able to build one or more progressive funds for the player using any of the embodiments described herein and using either of the methods taught in connection with FIGS. 3 and 4. Progressive fund tracking card 90 enables the player to eventually recoup amounts that the player personally funds to the various progressive pools described herein. The previous embodiments allow skilled and unskilled players on average to play a skill game, wherein the expected return, on average, is the same for the skilled and unskilled player. In previous embodiments, gaming device 10 pays back via the progressive payout funds lost through unsuccessful skill, strategy or risk to a player, not necessarily the player that performed unsuccessfully. With the progressive fund tracking card 90 and related systems, the player eventually recoups the player's own money lost due to unsuccessful play of a skill, strategy or risk event.

Card 90 can be used in a single casino or in multiple casinos and in designated types of gaming machines. Card 90 can be used with slot and video versions of poker, blackjack, Keno and any other suitable type of game. With a slot game as illustrated in FIGS. 1A and 1B, card 90 is insertable in one embodiment into payment acceptor 14.

The progressive fund tracking card and system can maintain multiple funds as described above. For example, the card and system can keep a fund that is based on unsuccessful skill, another fund based on losses due to unsuccessful risks and a further fund based on non-strategic play losses, such as non-strategic play of a video poker machine. The progressive fund tracking card can payout the progressive funds in a variety of ways, such as in gaming device credits, physical tokens, redeemable cash, casino prizes, casino meals, reduced or free boarding as well as other events and services provided by a casino or gaming establishment. It should be appreciated that such progressive amounts can be or may not be displayed to the players by the gaming machines.

It should be appreciated that the progressive fund for any of the above embodiments may be associated with the activation of a mechanical device such as a reel, wheel or die and that a payout of the progressive fund could be made upon a triggering event occurring on such gaming device.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A gaming device comprising:
a display device;
a skill, strategy or risk event displayed by the display device and operable by a player, the event having a winning outcome;
an award provided to the player when the player achieves the winning outcome in the event; and
a progressive payout at least partially funded from the award when the player does not achieve the winning outcome in the event.

2. The gaming device of claim 1, wherein the progressive payout is also funded from a wager made by the player.

3. The gaming device of claim 1, wherein the progressive payout is a linked progressive payout which is also funded by at least one other gaming device.

4. The gaming device of claim 1, which includes a game event separate from the skill, strategy or risk event, the separate game event providing the progressive payout as an outcome.

5. The gaming device of claim 4, wherein the separate game event is a primary game of the gaming device.

6. The gaming device of claim 4, wherein the separate game event is a bonus game of the gaming device.

7. The gaming device of claim 4, wherein the separate game includes an event selected from a group consisting of: a random game event, a plurality of random game events and each random game event associated with a paytable of the gaming device.

8. The gaming device of claim 1, wherein the progressive payout is provided to the player if the player achieves the winning outcome in the skill, strategy or risk event.

9. The gaming device of claim 1, wherein the skill, strategy or risk event is in a bonus game of the gaming device.

10. The gaming device of claim 1, which includes a touch screen operating in cooperation with the display device, wherein the winning outcome is determined by the player's selection of a particular area on the touch screen.

11. The gaming device of claim 1, which includes a touch screen operating in cooperation with the display device, wherein the winning outcome is determined by the player's selection of the touch screen at a particular time.

12. The gaming device of claim 1, which includes a plurality of electromechanical devices operating in cooperation with the display device, wherein the winning outcome is determined by the player's selection of one of said electromechanical devices.

13. The gaming device of claim 1, wherein the skill, strategy or risk event is selected from the group consisting of: a testing of the player's knowledge, a testing of the player's memory, a testing of the player's motor skills and any combination thereof.

14. The gaming device of claim 1, wherein the skill, strategy or risk event includes a shell game.

15. The gaming device of claim 14, wherein shells of the shell game are moved at a speed set so that some but not all players can achieve the winning outcome.

16. The gaming device of claim 1, wherein the skill, strategy or risk event includes an offer/acceptance game and the winning outcome includes obtaining an award that exceeds an expected value for the offer/acceptance game.

17. The gaming device of claim 16, wherein the amount funded to the progressive payout includes a difference between a rejected offer and the expected value.

18. The gaming device of claim 1, wherein the skill, strategy or risk event includes a difficulty level that is controlled adaptively with a goal of making an actual success rate for the event match a desired success rate.

19. The gaming device of claim 1, which includes a plurality of progressive payouts at least partially funded from the award when the player does not achieve the winning outcome in the skill, strategy or risk event.

20. The gaming device of claim 1, which includes a plurality of a progressive payouts, one of which is at least partially funded from the award when the player does not achieve the winning outcome in the skill, strategy or risk event.

21. The gaming device of claim 1, wherein the progressive fund is associated with the player.

22. The gaming device of claim 21, wherein the progressive fund is partially funded by wager amounts made by the player.

23. A gaming device comprising:
a display device;
a random generation device adapted to generate an outcome for a skill, strategy or risk event displayed by the display device;
an award provided to the player when the generation device generates a winning outcome for the event and the player selects an input associated with the winning outcome; and
a progressive payout at least partially funded from the award when the generation device generates a winning outcome for the event and the player selects an input not associated with the winning outcome.

24. The gaming device of claim 23, wherein the progressive payout is also funded from a wager made by the player.

25. The gaming device of claim 23, wherein the progressive payout is a linked progressive payout which is also funded by at least one other gaming device.

26. The gaming device of claim 23, which includes a game event separate from the skill, strategy or risk event, the separate game event providing the progressive payout as an outcome.

27. The gaming device of claim 26, wherein the separate game event is a primary game of the gaming device.

28. The gaming device of claim 26, wherein the separate game event is a bonus game of the gaming device.

29. The gaming device of claim 26, wherein the separate game includes an event selected from a group consisting of: the skill event, a random game event, a plurality of random game events and each random game event associated with a paytable of the gaming device.

30. The gaming device of claim 23, wherein the progressive payout is provided to the player if the winning outcome is generated and the player selects an input associated with the winning outcome.

31. The gaming device of claim 23, wherein the skill, strategy or risk event is a bonus game event.

32. The gaming device of claim 23, which includes a touch screen operating in cooperation with the display device, wherein the input associated with the winning outcome is selected by the player touching a particular area on the touch screen.

33. The gaming device of claim 23, which includes a touch screen operating in cooperation with the display device, wherein the input associated with the winning outcome is selected by the player touching the touch screen at a particular time.

34. The gaming device of claim 23, which includes a plurality of electromechanical devices operating in cooperation with the display device, wherein the input associated with the winning outcome is determined by the player's selection of a particular electromechanical device.

35. The gaming device of claim 23, wherein the skill, strategy or risk event is selected from the group consisting of: a testing of the player's knowledge, a testing of the player's memory, a testing of the player's motor skills and any combination thereof.

36. The gaming device of claim 23, wherein the skill, strategy or risk event includes a shell game.

37. The gaming device of claim 36, wherein shells of the shell game are moved at a speed set so that some but not all players can achieve the winning outcome.

38. The gaming device of claim 23, wherein the skill, strategy or risk event includes an offer/acceptance game and the winning outcome includes obtaining an award that exceeds an expected value for the offer/acceptance game.

39. The gaming device of claim 38, wherein the amount funded to the progressive payout includes a difference between a rejected offer and the expected value.

40. The gaming device of claim 23, which includes a plurality of a progressive payouts at least partially funded from the award when the player does not achieve the winning outcome in the skill, strategy or risk event.

41. The gaming device of claim 23, which includes a plurality of a progressive payouts, one of which is at least partially funded from the award when the player does not achieve the winning outcome in the skill, strategy or risk event.

42. The gaming device of claim 23, wherein the progressive fund is associated with the player.

43. The gaming device of claim 42, wherein the progressive fund is partially funded by wager amounts made by the player.

44. A gaming device comprising:
a display device;
a skill, strategy or risk event displayed by the display device and operable by a player, the event having a winning outcome;
an award provided to the player when the player achieves the winning outcome in the event; and
an output of a game separate from a game providing the skill, strategy or risk event, the output at least partially funded from the award when the player does not achieve the winning outcome in the event.

45. The gaming device of claim 44, wherein the separate game is a bonus game of the game providing the skill, strategy or risk event.

46. The gaming device claim 44, wherein the output is in a secondary game.

47. A method for operating a gaming device, the method comprising the steps of:
(a) displaying a skill, strategy or risk event having a winning outcome;
(b) receiving a player input;
(c) providing an award to the player if the player's input produces the winning outcome; and
(d) allocating at least a portion of the award to a progressive payout if the player's input does not produce the winning outcome.

48. The method of claim 47, which includes providing the progressive payout to the player if the player's input produces the winning outcome.

49. The method of claim 47, which includes providing the progressive payout to the player as an outcome of a game that is separate from the skill, strategy or risk event.

50. The method of claim 49, wherein the separate game is selected from the group consisting of: a base game and a bonus game.

51. The method of claim 47, wherein the player's input includes one of: (i) touching a particular area on the touch screen, (ii) selecting a particular electromechanical device, (iii) and selecting the input at a particular time.

52. The method of claim 47, wherein the event includes one of evaluating the player's knowledge, evaluating the player's memory and evaluating the player's motor skills.

53. The method of claim 47, wherein the progressive payout is also funded from one of: a player's wager and at least on other gaming device.

54. The method of claim 47, wherein displaying the event includes moving a plurality of shells, one of the shells covering an object.

55. The method of claim 47, wherein displaying the event includes providing an offer to the player and enabling the offer to be accepted or rejected.

56. The method of claim 47, which includes adaptively controlling the skill, strategy or risk event difficulty to match an actual success rate for the event to a desired success rate.

57. The method of claim 47, which includes allocating at least the portion of the award to a plurality of a progressive payouts.

58. The method of claim 47, which includes allocating at least the portion of the award to one of a plurality of a progressive payouts.

59. The method of claim 47, which includes allocating at least the portion of the award to a personal player progressive fund.

60. The method of claim 47, which is provided via a data network.

61. The method of claim 60, wherein the data network includes an internet.

62. A method for operating a gaming device, the method comprising the steps of:
(a) randomly determining an outcome for a skill, strategy or risk event;
(b) receiving the player's input in the event;
(c) providing an award to the player when a winning outcome for the event is randomly determined and the player selects an input associated with the winning outcome; and
(d) allocating at least a portion of the award to a progressive payout if the winning outcome is generated but the player selects an input not associated with the winning outcome.

63. The method of claim 62, which includes providing the progressive payout to the player if the player's input produces the winning outcome.

64. The method of claim 62, which includes providing the progressive payout to the player as an outcome of a game that is separate from the skill, strategy or risk event.

65. The method of claim 64, wherein the separate game is selected from the group consisting of: a base game and a bonus game.

66. The method of claim 62, wherein the player's input includes one of: (i) touching a particular area on the touch screen, (ii) selecting a particular electromechanical device, (iii) and selecting the input at a particular time.

67. The method of claim 62, wherein the event includes one of evaluating the player's knowledge, evaluating the player's memory and evaluating the player's motor skills.

68. The method of claim 62, wherein the progressive payout is also funded from one of: a player's wager and at least on other gaming device.

69. The method of claim 62, wherein displaying the event includes moving a plurality of shells, one of the shells covering an object.

70. The method of claim 62, wherein displaying the event includes providing an offer to the player and enabling the offer to be accepted or rejected.

71. The method of claim 62, which includes adaptively controlling the skill, strategy or risk event difficulty to match an actual success rate for the event to a desired success rate.

72. The method of claim 62, which includes allocating at least the portion of the award to a plurality of a progressive payouts.

73. The method of claim 62, which includes allocating at least the portion of the award to one of a plurality of a progressive payouts.

74. The method of claim 62, which includes allocating at least the portion of the award to a personal player progressive fund.

75. The method of claim 62, which is provided via a data network.

76. The method of claim 75, wherein the data network includes an internet.

77. A gaming device comprising:
a display device;
a skill event which is displayed by the display device and operable by a player, the skill event having a winning outcome;
an award provided to the player when the player achieves the winning outcome in the skill event; and
a progressive payout at least partially funded from the award when the player does not achieve the winning outcome in the skill event, wherein the progressive payout is awarded upon the occurrence of a game event.

78. The gaming device of claim 77, wherein the progressive payout is also funded from a wager made by the player.

79. The gaming device of claim 77, wherein the progressive payout is a linked progressive payout which is also funded by at least one other gaming device.

80. A gaming device comprising:
a progressive award;
an event operable by a player having a successful outcome and a non-successful outcome in said event;
an award provided to the player upon the successful outcome; and
at least a portion of said award added to said progressive award when the player obtains a non-successful outcome in said event.
